(19) United States
(12) Patent Application Publication
(10) Pub. No.: US 2014/0325532 A1
(43) Pub. Date: Oct. 30, 2014

(54) MICROMINIATURE PERSONAL COMPUTER AND METHOD OF USING THEREOF

(71) Applicants: Wagan Sarukhanov, Moscow (RU); Igor Komov, Moscow (RU); Alexander Podelko, Stamford, CT (US)

(72) Inventors: Wagan Sarukhanov, Moscow (RU); Igor Komov, Moscow (RU); Alexander Podelko, Stamford, CT (US)

(21) Appl. No.: 14/271,857

(22) Filed: May 7, 2014

Related U.S. Application Data
(63) Continuation-in-part of application No. 12/624,724, filed on Nov. 24, 2009, now abandoned.

(30) Foreign Application Priority Data
Aug. 24, 2009 (RU) 2009131804

(51) Int. Cl. G06F 13/10

(52) U.S. Cl. CPC G06F 13/102
USPC 719/321

(57) ABSTRACT

A microminiature personal computer that is connected to external devices using standard interfaces for information input and output. The microminiature personal computer has an interconnected processor, a memory, a security module, a network module, and a connector. At least part of memory should be non-volatile to keep operating system, drivers to work with external devices, programs and data. The microminiature personal computer does all its processing and all its programs are running inside its memory while external computing device is used only for information input and output through a virtual window thus ensuring security of both systems and lack of unauthorized interaction between them.

### BACKGROUND OF THE INVENTION

The present invention relates to a microminiature personal computer, i.e., a small form factor general-purpose computer using external devices for information input and output.

In computing, a form factor specifies the physical dimensions of major system components. There were numerous efforts to create small form-factor devices which would be really small and portable and provide functionality of general-purpose computer. It is possible to classify these efforts into several categories.

The largest category is small computers with built-in devices for user information input and output, sometimes referred to as mobile computing. There are many groups of such devices and they are marketed under different names, including pocket personal computer (PC), personal digital assistant (PDA), tablet PC, handheld PC, micro PC, smart phone, ultra-mobile PC.

Including user interface doesn't allow to decrease the size of these devices beyond certain limits due to requirements imposed by human-computer interaction (to be usable, screen and keyboard can't be too small). Small input/output devices often require special software and limit functionality.

Another category are portable computers without user interface, but requiring special hosting devices to be attached to. While there are many inventions claimed (20060253894, U.S. Pat. No. 6,538,880, 20020097555, U.S. Pat. Nos. 7,533,408, 5,264,992, 5,708,840, 6,029,183, 20090200367), devices embodied such inventions are expected to use special hosting devices.

The third large group, sometimes referred to as software mobility or portable platforms, is a technology of storing software and data in a mobile storage medium. When the device is attached to a host computer, these programs may be loaded into the host computer and executed there.

All processing is done by the host computer in this case, so it limits what programs can be run. Security risk is higher because the host computer and the storage device are not isolated.

It would be desirable to implement in small form factor (such as USB-flash form factor) a microminiature personal computer equipped to do all processing so all programs run inside the microminiature personal computer. That way, an external computing device, to which the microminiature personal computer is connected, is used only for information input and output through a virtual window. As a result, security of both systems is assured because there will be a lack of unauthorized interaction between them. The external device wouldn't require any modification beyond virtual window driver installation and may continue to be used for its own data processing and have its own virtual windows opened.

### SUMMARY OF THE INVENTION

One aspect of the invention relates to a microminiature personal computer, which interconnects a processor, a memory, a security module, a network module, and a connector and uses external devices for information input and output. At least part of memory should be non-volatile to keep operating system, drivers to work with external devices, programs and data. Microminiature personal computer does all its processing and all its programs are running inside its memory while external device is used only for information input and output through a virtual window thus ensuring security of both systems and lack of unauthorized interaction between them.

Another aspect of the invention relates to a method assembling a microminiature personal computer into an operative condition by connecting it to an external device, the microminiature personal computer having an operating system equipped to do all its processing so all its programs run inside the microminiature personal computer. The external device, as it relates to the microminiature personal computer, being used only for information input and output through a virtual window to interface with the operating system of the microminiature personal computer (and still may be used for its own processing in parallel).

A further aspect of the invention resides in a method of use involving running an operating system and programs by a microminiature personal computer connected to an external device, entering information via a user interface of the external device, processing the entered information by the operating system and programs inside the microminiature personal computer and sending results of the processed information to the external device, where it can be sent, for example, to a display, speaker or a network connected device.

The processor speed and memory volume of the microminiature personal computer are sufficient for running office, business and game program under supervision of its Operating System, access to Local Area Network and Internet, playing audio- and video-information.

Desktop or portable computers can be used as external computing devices, as well as smart phones, personal digital assistants, and multimedia devices such as musical centers and TV sets. Different interfaces can be used to connect to external input/output devices; for example, USB, HDMI, IEEE 1394, LPT, Ethernet, WiFi, and Bluetooth. USB is a universal serial bus for connection, communication, and power supply between computers and electronic devices. HDMI is a high definition multimedia interface that serves as a compact audio/video interface for transferring uncompressed video data and compressed or uncompressed digital audio data from a HDMI-compliant source device to a compatible computer monitor, video projector, digital television, or digital audio device. IEEE 1394 is a serial bus interface standard for high-speed communications and isochronous real-time data transfer. LPT is a line print terminal for a parallel port connection to a printer or other device on a personal computer. Ethernet is a family of networking technologies for local area networks. WiFi is a technology that allows an electronic device to exchange data or connect to the internet wirelessly using radio waves. Bluetooth is a wireless technology standard for exchanging data over short distances (using short-wavelength UHF radio waves in the ISM band from 2.4 to 2.485 GHz) from fixed and mobile devices, and building personal area networks (PANs).

While the microminiature personal computer uses many standard computer elements and interfaces, the combination of all of the following elements makes it unique:
the microminiature personal computer has computing power to do all processing
the external generic computing device does not require modification (beyond driver installation)
standard interfaces/connectors are used to connect the microminiature personal computer and the external computing device
the virtual window driver that support input and output information by the interfaces of the external computing device through a virtual window opened on its screen
the external computing device remains working, may do its own unrelated processing, control the screen but the microminiature personal computer virtual window and may open other virtual windows there
the microminiature personal computer virtual window is used only for transferring information to the microminiature personal computer where all processing is done in full isolation from the external computing device
only the virtual window driver area of the non-volatile memory may be accessed by the external computing device; the program and data area of the non-volatile memory of the microminiature personal computer remains unaccessable from the external computing device to ensure security.
the external computing device does not have any direct access to programs or data on the microminiature personal computer.

While many other patents or devices may have a subset of above elements, only the combination of all of them comprises the secure solution based on the microminiature personal computer.

### BRIEF DESCRIPTION OF THE DRAWING

FIG. 1 is a block diagram of the microminiature personal computer attached to an external computer.

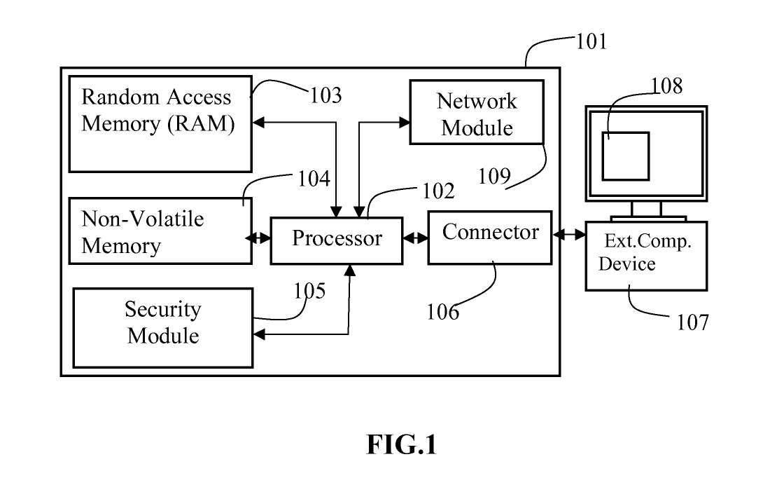

FIG. 2 is a flowchart of the microminiature personal computer.

### DETAILED DESCRIPTION OF THE PREFERRED EMBODIMENT

A microminiature personal computer 101, which could be implemented in USB-flash form factor, comprises an interconnected processor 102, a random access memory 103, a non-volatile memory 104, a security module 105, a network module 109, and a connector 106. The microminiature personal computer 101 can be attached by connector 106 to an external computing device 107, which works as an external input/output device.

Non-volatile memory 104 of the microminiature personal computer consists of at least two areas. One area is intended for the Operating System, personal data, and programs, and has an ability to be logically attached to the Operating System of external computer as a virtual storage device. Another area is intended for a virtual window driver that may be activated on the external computer 107 and create at least one virtual window 108 on the screen of the external computer.

After attaching the microminiature personal computer 101 to the external computer 107 by the connector 106, the processor 102 loads programs under the Operating System supervision from non-volatile memory 104 into RAM 103 and starts them. After virtual windows driver installation, a virtual window 108 is created on the screen of the external personal computer 107, which is used for output of the programs executed by the microminiature personal computer 101. The keyboard, the mouse, and the other devices of the external computing device 107 are used for information input and output of for the programs executed by the microminiature personal computer 101 and associated with the virtual window 108. Personal data and programs may be encrypted by security module 105.

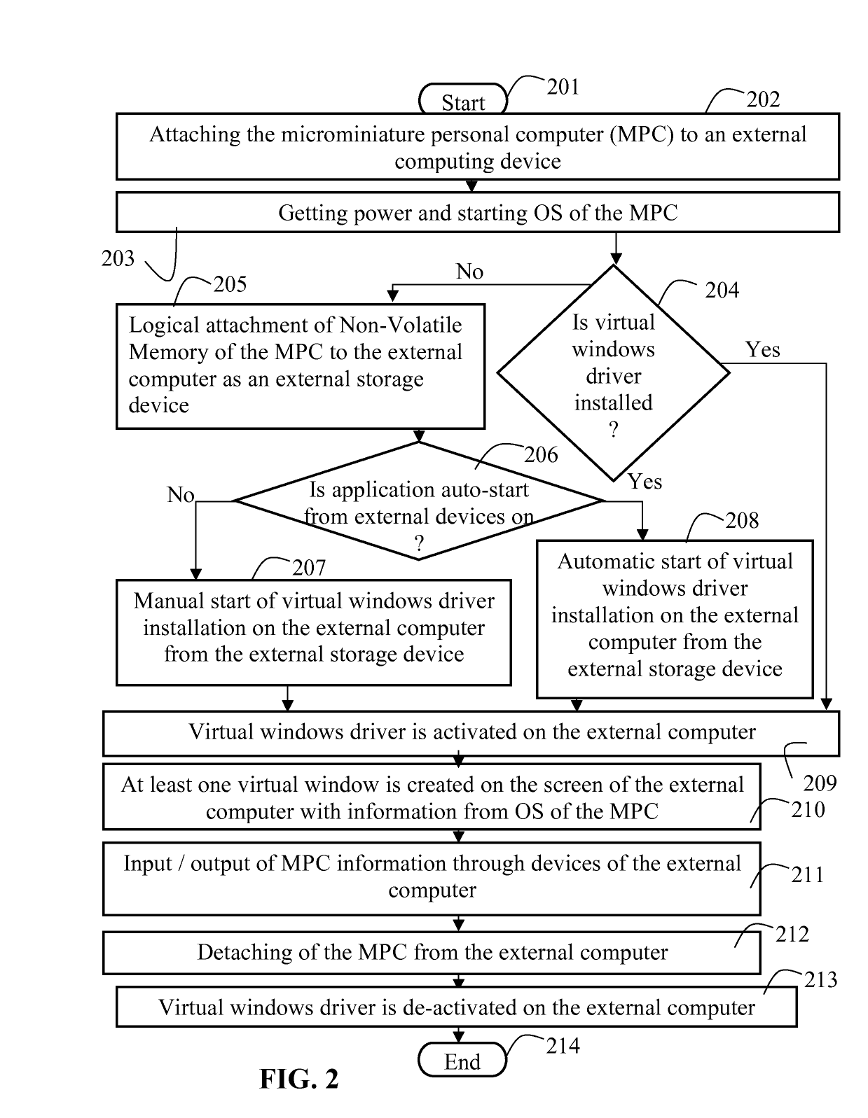

According to the flowchart shown on FIG. 2, the microminiature personal computer 101 is working as following:
Step 201: Start
Step 202: Attaching the microminiature personal computer 101 to the external computer 107 by connector 106
Step 203: Starting of the microminiature personal computer 101
Step 204: If the virtual window driver was installed on the external computing device 107, go to step 209
Step 205: Logical attachment of the virtual window driver area of the non-volatile memory 104 of the microminiature personal computer 101 to the external computer 107 as an external storage device. The program and data area of the non-volatile memory 104 of the microminiature personal computer 101 remains inaccessible from the external computing device 107 to ensure security.
Step 206: If the application auto-start from external devices is allowed on the external computing device 107, go to step 208
Step 207: Manual start of the virtual window driver installation on the external computing device 107. Go to step 209
Step 208: Automatic start of the virtual window driver installation on the external computing device 107
Step 209: Activating of the virtual window driver on the external computing device 107
Step 210: The virtual window driver creates at least one virtual window 108 on the screen of the external computing device 107 for communication with the microminiature personal computer 101. A secure protocol is used for communication between the virtual window 108 and the microminiature personal computer 101. The external computing device 107 remains working, may do its own unrelated processing, control the screen but the microminiature personal computer virtual window and may open other virtual windows there. For the user it looks like he continues to work with the external computing device as usual, but sees the microminiature personal computer as another computer connected to the network and sees its desktop in the virtual window 108.
Step 211: Work with the microminiature personal computer is conducted by input and output of information from the microminiature personal computer 101 through the created virtual window 108 by user interface devices of the external computing device 107 while the programs are executed inside the microminiature personal computer 101.
The user may use keyboard, mouse, and other user interface devices of the external computing device to work with programs inside the microminiature personal computer when the cursor is inside the virtual window.
The created virtual window 108 is the only way of communication between the external computing device 107 and the microminiature personal computer 101, the external computing device 107 may not access or modify programs or data on the microminiature personal computer. When the user works with programs of the microminiature personal computer through the virtual window, all processing is done inside the microminiature personal computer 101 in full isolation from the external computing device 107.
Step 212: Detaching the microminiature personal computer 101 from the external computer 107 when work is done
Step 213: De-activating the virtual windows driver on the external computer 107
Step 214: End

Based on these steps, a method may be realized in accordance with a preferred embodiment: of communication between a microminiature personal computer and an external computing device. The method includes the steps of:

operating a microminiature personal computer to install a virtual window driver on an external computing device as the microminiature personal computer is attached to the external computer device, the microminiature personal computer having an interconnected processor, a non-volatile memory, a random access memory, a security module, a network module, and a connector, the connector making an attachment to an external computer device, the non-volatile memory having a first area accommodating an operating system, data and at least one program and having a second area accommodating a virtual window driver configured to create via the connector at least one microminiature personal computer virtual window on a screen of the external computer device;

activating the virtual window driver to open the at least one microminiature personal computer virtual window on the screen of the external computer device;

exclusively programming all content of the microminiature personal computer virtual window with the microminiature personal computer and without programming the content from the external computing device;

communicating input and output information via secure protocol between the microminiature personal computer and the external computing device only through the at least one microminiature personal computer virtual window with data residing and at least one computer program executing inside the microminiature personal computer, the communicating being carried out with at least one user interface device of the external computer device that moves a cursor on the screen of the external computer device within the at least one microminiature personal computer virtual window;

enabling the communicating of the input information as the cursor moves within the at least one microminature personal computer virtual window and disabling the communicating of the input information as the cursor moves outside the at least one microminature personal computer virtual window; and

processing the data residing and the at least one computer program executing inside the microminiature personal computer in full isolation from the external computing device and in a manner that renders inaccessible to the external computing device the residing data and the executing at least one computer program of the microminiature personal computer.

If desired, there may be operating the external computing device to control the screen and perform processing unrelated to that of the microminiature personal computer; opening additional virtual windows on the screen; and exclusively programming all content of the additional virtual windows with the microminiature personal computer.

If desired, there may be providing under exclusive programming control of the microminiature personal computer an image of an desktop that appears within the at least one microminiature personal computer virtual window. Instead of a desktop image, there may be displayed an image of a screen of a particular program.

Further, detaching the microminiature personal computer from the external computer to sever the communicating; and de-activating the virtual window driver on the external computer in response to the detaching.

Also, implementing the microminiature personal computer in USB-flash form factor.

As should be appreciated from the steps involved In the method, the present invention is also directed to an apparatus suited to effect communication between a microminiature personal computer and an external computing device. The apparatus includes

means for operating a microminiature personal computer to install a virtual window driver on an external computing device as the microminiature personal computer is attached to the external computer device;

means for activating the virtual window driver to open at least one microminiature personal computer virtual window on a screen of the external computer device;

means for exclusively programming all content of the microminiature personal computer virtual window with the microminiature personal computer and without programming the content from the external computing device;

means for communicating input and output information via secure protocol between the microminiature personal computer and the external computing device only through the at least one microminiature personal computer virtual window with data residing and at least one computer program executing inside the microminiature personal computer, the means for communicating including at least one user interface device of the external computing device that moves a cursor on the screen of the external computing device within the at least one microminiature personal computer virtual window;

means for enabling the means for communicating of the input data as the cursor moves within the at least one microminiature personal computer virtual window and for disabling the means for communicating of the input data as the cursor moves outside the at least one microminiature personal computer virtual window; and

means for processing the data residing and the at least one computer program executing inside the microminiature personal computer in full isolation from the external computing device and in a manner that renders inaccessible to the external computing device the residing data and the executing at least one computer program of the microminiature personal computer.

If desired, the apparatus may have means for operating the external computing device to control the screen and perform processing unrelated to that of the microminiature personal computer; said microminiature personal computer having means for opening additional virtual windows on the screen and means for exclusively programming all content of the additional virtual windows.

There may also be means for providing under exclusive programming control of the microminiature personal computer an image of a desktop that appears within the at least one microminiature personal computer virtual window.

There is means for de-activating the virtual windows driver on the external computer in response to the detaching the microminiature personal computer from the external computing device.

Also, there is means for implementing the microminiature personal computer in USB-flash form factor.

Preferably, the external computer device for information input and output is selected from the group consisting of a desktop computer, a portable computer, a musical center, a TV set, a home theater, a smart phone, a personal digital assistant, a multifunctional multimedia device, a multifunctional car panel, a USB interface to attach to further external devices, an IEEE 1394 interface to attach to further external devices, an Ethernet interface to attach to further external devices, a WiFi interface to attach to further external devices, a Bluetooth interface to attach to further external devices.

What is claimed is:

1. A method of communication between a microminiature personal computer and an external computing device, comprising the steps of:
operating a microminiature personal computer to install a virtual window driver on an external computing device as the microminiature personal computer is attached to the external computer device, the microminiature personal computer having an interconnected processor, a non-volatile memory, a random access memory, a security module, a network module, and a connector, the connector making an attachment to an external computer device, the non-volatile memory having a first area accommodating an operating system, data and at least one program and having a second area accommodating a virtual window driver configured to create via the connector at least one microminiature personal computer virtual window on a screen of the external computer device;
activating the virtual window driver to open the at least one microminiature personal computer virtual window on the screen of the external computer device;
exclusively programming all content of the microminiature personal computer virtual window with the microminiature personal computer and without programming the content from the external computing device;
communicating input and output information via secure protocol between the microminiature personal computer and the external computing device only through the at least one microminiature personal computer virtual window with data residing and at least one computer program executing inside the microminiature personal computer, the communicating being carried out with at least one user interface device of the external computer device that moves a cursor on the screen of the external computer device within the at least one microminiature personal computer virtual window;
enabling the communicating of the input information as the cursor moves within the at least one microminature personal computer virtual window and disabling the communicating of the input information as the cursor moves outside the at least one microminature personal computer virtual window; and
processing the data residing and the at least one computer program executing inside the microminiature personal computer in full isolation from the external computing device and in a manner that renders inaccessible to the external computing device the residing data and the executing at least one computer program of the microminiature personal computer.

2. The method of claim 1, further comprising operating the external computing device to control the screen and perform processing unrelated to that of the microminiature personal computer; opening additional virtual windows on the screen; and exclusively programming all content of the additional virtual windows with the microminiature personal computer.

3. The method of claim 1, further comprising providing under exclusive programming control of the microminiature personal computer an image of a desktop that appears within the at least one microminiature personal computer virtual window.

4. The method of claim 1, further comprising detaching the microminiature personal computer from the external computer to sever the communicating; and de-activating the virtual window driver on the external computer in response to the detaching.

5. The method of claim 1, further comprising implementing the microminiature personal computer in USB-flash form factor.

6. The method of claim 1, further comprising selecting the external computer device for information input and output from the group consisting of a desktop computer, a portable computer, a musical center, a TV set, a home theater, a smart phone, a personal digital assistant, a multifunctional multimedia device, a multifunctional car panel, a USB interface to attach to further external devices, a 1394 interface to attach to further external devices, an Ethernet interface to attach to further external devices, a WiFi interface to attach to further external devices, a Bluetooth interface to attach to further external devices.

7. The method of claim 1, further comprising establishing connection between the microminiature personal computer and the external computing device via an interface selected from the group consisting of USB, HDMI, IEEE 1394, LPT, Ethernet, WiFi, and Bluetooth.

8. An apparatus suited to effect communication between a microminiature personal computer and an external computing device, comprising:
means for operating a microminiature personal computer to install a virtual window driver on an external computing device as the microminiature personal computer is attached to the external computer device;
means for activating the virtual window driver to open at least one microminiature personal computer virtual window on a screen of the external computer device;
means for exclusively programming all content of the microminiature personal computer virtual window with the microminiature personal and without programming the content from the external computing device;
means for communicating input and output information via secure protocol between the microminiature personal computer and the external computing device only through the at least one microminiature personal computer virtual window with data residing and at least one computer program executing inside the microminiature personal computer, the means for communicating including at least one user interface device of the external computing device that moves a cursor on the screen of the external computing device within the at least one microminiature personal computer virtual window;
means for enabling the means for communicating of the input data as the cursor moves within the at least one microminiature personal computer virtual window and for disabling the means for communicating of the input data as the cursor moves outside the at least one microminiature personal computer virtual window; and
means for processing the data residing and the at least one computer program executing inside the microminiature personal computer in full isolation from the external computing device and in a manner that renders inaccessible to the external computing device the residing data and the executing at least one computer program of the microminiature personal computer.

9. The apparatus of claim 8, further comprising means for operating the external computing device to control the screen and perform processing unrelated to that of the microminiature personal computer; said microminiature personal computer having means for opening additional virtual windows on the screen and means for exclusively programming all content of the additional virtual windows.

10. The apparatus of claim 8, further comprising means for providing under exclusive programming control of the microminiature personal computer an image of a desktop that appears within the at least one microminiature personal computer virtual window.

11. The apparatus of claim 8, further comprising means for de-activating the virtual windows driver on the external computer in response to the detaching the microminiature personal computer from the external computing device.

12. The apparatus of claim 8, further comprising means for implementing the microminiature personal computer in USB-flash form factor.

13. The apparatus of claim 8, wherein the external computer device for information input and output is selected from the group consisting of a desktop computer, a portable computer, a musical center, a TV set, a home theater, a smart phone, a personal digital assistant, a multifunctional multimedia device, a multifunctional car panel, a USB interface to attach to further external devices, a 1394 interface to attach to further external devices, an Ethernet interface to attach to further external devices, a WiFi interface to attach to further external devices, a Bluetooth interface to attach to further external devices.

14. The apparatus of claim 8, further comprising a connection established between the microminiature personal computer and the external computing device via an interface selected from the group consisting of USB, HDMI, IEEE 1394, LPT, Ethernet, WiFi, and Bluetooth.
